(19) United States
(12) Patent Application Publication
(10) Pub. No.: US 2015/0127576 A1
(43) Pub. Date: May 7, 2015

(54) RECOMMENDATIONS AS AN INCENTIVE TO RATE

(71) Applicants: Benjamin L. Grol-Prokopczyk, San Francisco, CA (US); Agnieszka M. Madurska, London (GB); Luis Alejandro Sigal, London (GB)

(72) Inventors: Benjamin L. Grol-Prokopczyk, San Francisco, CA (US); Agnieszka M. Madurska, London (GB); Luis Alejandro Sigal, London (GB)

(73) Assignee: Google Inc., Mountain View, CA (US)

(21) Appl. No.: 13/600,154

(22) Filed: Aug. 30, 2012

Related U.S. Application Data
(60) Provisional application No. 61/531,563, filed on Sep. 6, 2011.

(51) Int. Cl. G06Q 30/02; G06Q 30/00

(52) U.S. Cl. CPC G06Q 30/0282
USPC 705/347

(57) ABSTRACT

Various aspects of the subject technology relate to systems, methods, and machine-readable media for providing recommendations as an incentive for a user to contribute a rating on a topic are provided. A system may be configured to receive a user rating of a topic from a client device, wherein the user rating is associated with a user, increment a count associated with the user in response to receiving the user rating of the topic, and determine whether the count exceeds a threshold. If the count exceeds the threshold, the system may generate a plurality of recommendations for the user based on the user rating of the topic and provide a subset of the plurality of recommendations for the user.

### RELATED APPLICATION

This application claims priority to U.S. provisional patent application 61/531,563, filed on Sep. 6, 2011, “RECOMMENDATIONS AS AN INCENTIVE TO RATE,” the contents of which are herein incorporated by reference in its entirety.

### BACKGROUND

Many services allow users to rate and review topics such as consumer products, points of interests (e.g., businesses such as restaurants), and services. The services may collect these ratings from various users and store the ratings in a database. Users may then access the ratings and reviews of these topics made by other people. For example, a user wishing to view the ratings and reviews of a particular restaurant may search for the restaurant in a search interface. In response to the search query, the service may provide the user with a user interface containing information about the restaurant as well as other users' ratings and reviews of the restaurant.

In general, services providing ratings and reviews benefit from more users providing more ratings of a greater number of topics. For example, services having more ratings and reviews are typically able to provide users with more in-depth information about a topic from more perspectives. Furthermore, ratings and reviews may be more reliable because they are based on more data points and a larger sample size.

However, the number of users that actively contribute ratings and reviews may be quite small compared to the total number of users. In some cases, only a few users may provide ratings and reviews while a vast majority of other users are passive users that only consume the information provided by a rating service. For many users, there is inadequate motivation to submit ratings and reviews of topics. Instead, many users simply consume information provided by the services instead of contributing ratings and reviews.

### SUMMARY

Various aspects of the subject technology relate to a system for providing recommendations in response to receiving a rating. The system may include one or more processors and a machine-readable medium comprising instructions stored therein, which when executed by the one or more processors, cause the one or more processors to perform operations. The operations may include receiving a rating of a first topic by a user, incrementing a count for the user in response to receiving the rating of the first topic, and determining whether the count exceeds a first threshold. If the count exceeds the first threshold, the operations may include generating a first plurality of recommendations for the user and providing a subset of the first plurality of recommendations for the user.

Other aspects of the subject technology relate to a method for providing recommendations in response to receiving a rating. The method may include receiving a rating of a first topic by a user, incrementing a count for the user in response to receiving the rating of the first topic, and determining whether the count exceeds a first threshold. If the count exceeds the first threshold, the method includes generating a first plurality of recommendations for the user based on the rating of the first topic and providing a subset of the first plurality of recommendations for the user.

Other aspects of the subject technology relate to a non-transitory machine- readable medium comprising instructions stored therein, which when executed by a machine, cause the machine to perform operations. The operations may include receiving a user rating of a topic from a client device, wherein the user rating is associated with a user, incrementing a count associated with the user in response to receiving the user rating of the topic, and determining whether the count exceeds a threshold. If the count exceeds the threshold, the operations may include generating a plurality of recommendations for the user based on the user rating of the topic and providing a subset of the plurality of recommendations for the user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate disclosed aspects of the subject technology and together with the description serve to explain the principles of the subject technology.

FIG. 1 is a conceptual block diagram illustrating an example environment for providing recommendations as an incentive to encourage a user to contribute a rating on a topic, in accordance with various aspects of the subject technology.

FIG. 2 illustrates two example user interfaces displayed to a user after the user submits a rating, in accordance with various aspects of the subject technology.

FIG. 3 is an example user interface displayed to a user after a system receives a rating submitted by a user, in accordance with various aspects of the subject technology.

FIG. 4 is a timing diagram that illustrates an example interaction between a user on a client device and a system configured to providing recommendations as an incentive, according to various aspects of the subject technology.

FIG. 5 is a flow chart illustrating an example process for providing recommendations as an incentive for a user to contribute a rating on a topic, in accordance with various aspects of the subject technology.

FIG. 6 is a block diagram illustrating an example computer system with which any of the clients, servers, or systems described herein may be implemented, in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Various aspects of the subject technology are related to systems and methods for providing recommendations as an incentive to encourage a user to contribute a rating on a topic. A system may be configured to generate customized recommendations for a user and present one or more of the customized recommendations to the user once the user has submitted a threshold number of ratings. The topics that may be rated may include points of interest (e.g., businesses, restaurants, stores etc.), consumer products, services, media (e.g., articles, books, music, movies, TV shows, etc.), or any other topic.

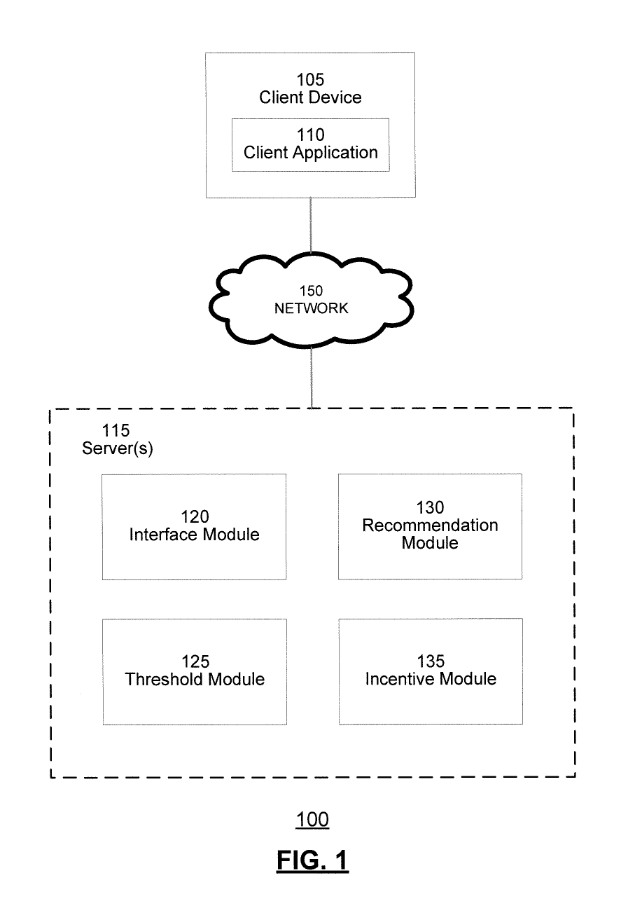

FIG. 1 is a conceptual block diagram illustrating an example environment 100 for providing recommendations as an incentive to encourage a user to contribute a rating on a topic, in accordance with various aspects of the subject technology. Although FIG. 1 illustrates a client-server network environment 100, other aspects of the subject technology may include other configurations including, for example, peer-to-peer environments or single system environments.

The network environment 100 may include at least one server 115 and at least one client device 105 connected over a network 150, such as the Internet. The network 150 may also include, for example, any one or more of a cellular network, a satellite network, a local area network (LAN), a wide area network (WAN), a broadband network (BBN), and the like.

The client device 105 may be any machine able to transmit to the server 115 a rating of a topic. The rating may include an indication of a user's opinion of the topic and/or a user's comments about the topic (e.g., a review). The client device 105 may also be able to receive communications such as recommendations from the server 115 and present the recommendations to a user. According to example aspects, the ratings and/or recommendations may be provided to a user within a social networking site, a local search site, a ratings site, or another website or application.

Example client devices 105 may include be a desktop computer, a laptop, a mobile device (e.g., a phone, tablet, personal digital assistant (PDA), etc.), a global positioning system (GPS) device, or any other machine with a processor, memory, and communications capabilities. The client device 105 may also include one or more client applications 110 (e.g., a web browser or an application) that may be configured to transmit ratings to the server 115, receive communications from the server 115, and generate a display for the user.

The server 115 may be any system or device having a processor, a memory, and communications capability that may be used to generate recommendations for a user and provide the recommendations to the user as an incentive for contributing a rating on a topic. In some aspects, the server 115 may be a virtual entity that might refer to a cluster or even multiple clusters of servers.

According to one aspect of the subject technology, the server 115 may include an interface module 120, a threshold module 125, a recommendation module 130, and an incentive module 135. While the server 115 is shown in one configuration in FIG. 1, in other configurations, the server 115 may include additional, alternative, and/or fewer components.

In FIG. 1, the interface module 120 may be configured to communicate with client devices 105 and other servers and receive ratings of one or more topics from a user. The threshold module 125 may be configured to keep track of the number of ratings a user has submitted and determine if the ratings that the user has submitted meets a predefined threshold. For example, if the number of ratings the user has submitted exceeds a threshold number of ratings, the recommendation module 130 may be configured to generate a number of recommendations for the user based on, for example, the ratings the user has submitted.

The incentive module 135 may be configured to provide some of these recommendations to the user as a reward for submitting the threshold number of ratings. However, not all of the generated recommendations may be provided to the user at the same time. Instead, the incentive module 135 may provide a subset of the generated recommendations to the user in response to the user reaching a first threshold and reserve other recommendations as a further incentive for the user to submit additional ratings.

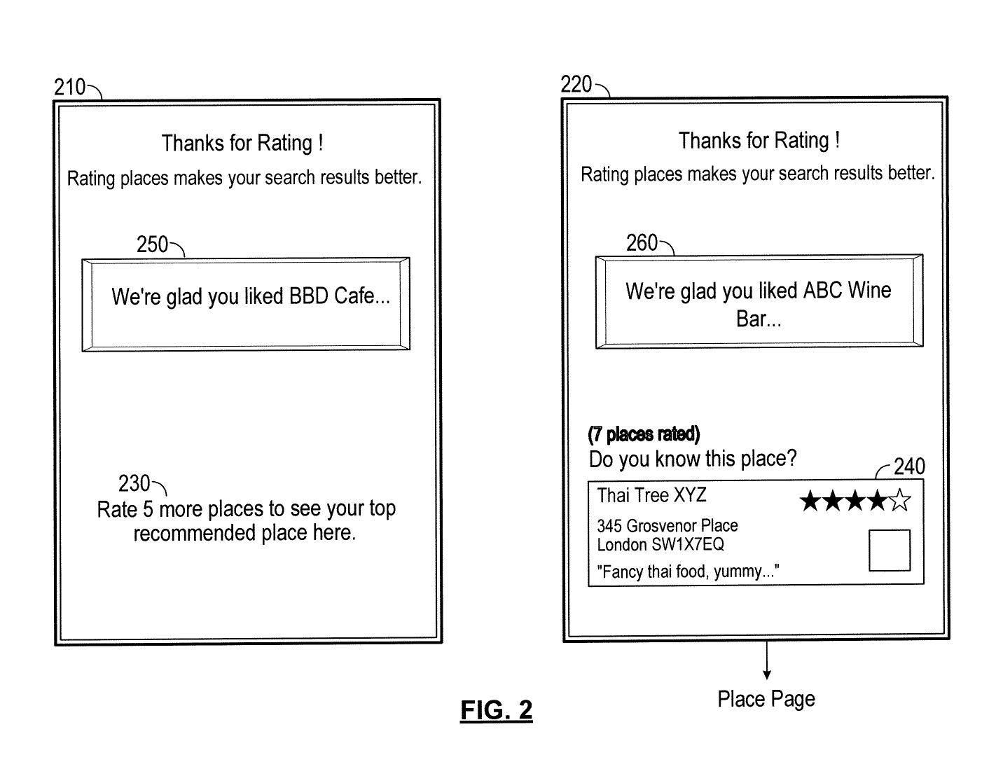

FIG. 2 illustrates two example user interfaces 210 and 220 displayed to a user after the user submits a rating, in accordance with various aspects of the subject technology. Although in FIG. 2, the user has submitted a rating for a point of interest (e.g., a place), according to other aspects, the rating may also be for other topics such as products or services.

After a rating of a topic is received by the interface module 120, the threshold module 125 may determine if the user has submitted at least a threshold number of ratings (e.g., 6 ratings). If the user has not submitted enough ratings, the user may be presented with a message indicating that the user needs to submit additional ratings before the user will be provided recommendations.

The threshold number of ratings needed to receive recommendations may be an arbitrary number of ratings that may be used to motivate a user to rate more places. However, according to another aspect, the threshold number may be bounded by a minimum number that represents the minimum number of ratings required to be able to generate reasonable recommendations for the user.

As an example, user interface 210 may be presented to the user in response to the user having submitted a positive rating for a point of interest called “BBD Cafe.” The user interface 210 may include a message thanking the user for submitting the rating. However, the rating submitted by the user may represent the user's first rating, and the threshold number of ratings needed in order to receive recommendations, in the illustrated example, is 6. Accordingly, the user interface 210 may include a message 230 indicating that the user needs to submit 5 more ratings before the user will be presented with recommendations.

In contrast, user interface 220 may be presented to the user in response to the user having submitted a positive rating for a point of interest called “ABC Wine Bar,” which may represent the 7th rating the user has submitted. Because the user has rated more than the threshold number of ratings needed to receive recommendations (e.g., 6 ratings), the user may be presented with one or more recommendations 240 for other points of interest.

The recommendation 240 may be accompanied with information about a point of interest such as the name of the point of interest, an address for the point of interest, an average user rating, one or more comments regarding the point of interest made by other users, and/or one or more pictures associated with the point of interest.

The recommendation 240 may also include one or more links to an interface (e.g., a web page) containing more information about the point of interest being recommended and/or interface elements that enable the user to rate the point of interest being recommended. According to another aspect, the recommendation 240 may itself include an interface element that may enable the user to rate the point of interest being recommended.

As will be discussed in further detail below, according to some aspects, the recommendation 240 shown in the user interface 220 may selected based on the point of interest most recently rated by the user (e.g., “ABC Wine Bar”). For example, the recommendation 240 for “Thai Tree XYZ” in user interface 220 may be selected from a number of recommendations generated for the user based on “Thai Tree XYZ” being located near the “ABC Wine Bar.” In other aspects the recommendation 240 for “Thai Tree XYZ” may be selected based on its similarities with “ABC Wine Bar” or based on a likelihood that the user, who liked “ABC Wine Bar,” would also like “Thai Tree XYZ.”

Although user interfaces 210 and 220 contain text 250 and 260 referencing the user's positive rating of a point of interest (e.g., a rating of 3 or more stars out of 5), in other aspects, other user interfaces may display custom text based on receiving a low rating for the point of interest by the user. For example, if the user rated ABC Wine bar 2 or less stars out of 5, the user interface may read “We're sorry you didn't like ABC Wine Bar” instead.

As discussed above, the recommendation displayed to a user may include one or more links to an interface (e.g., a web page) containing more information about the point of interest being recommended. In another aspect, however the recommendation may include an interface element that may enable the user to rate the point of interest being recommended.

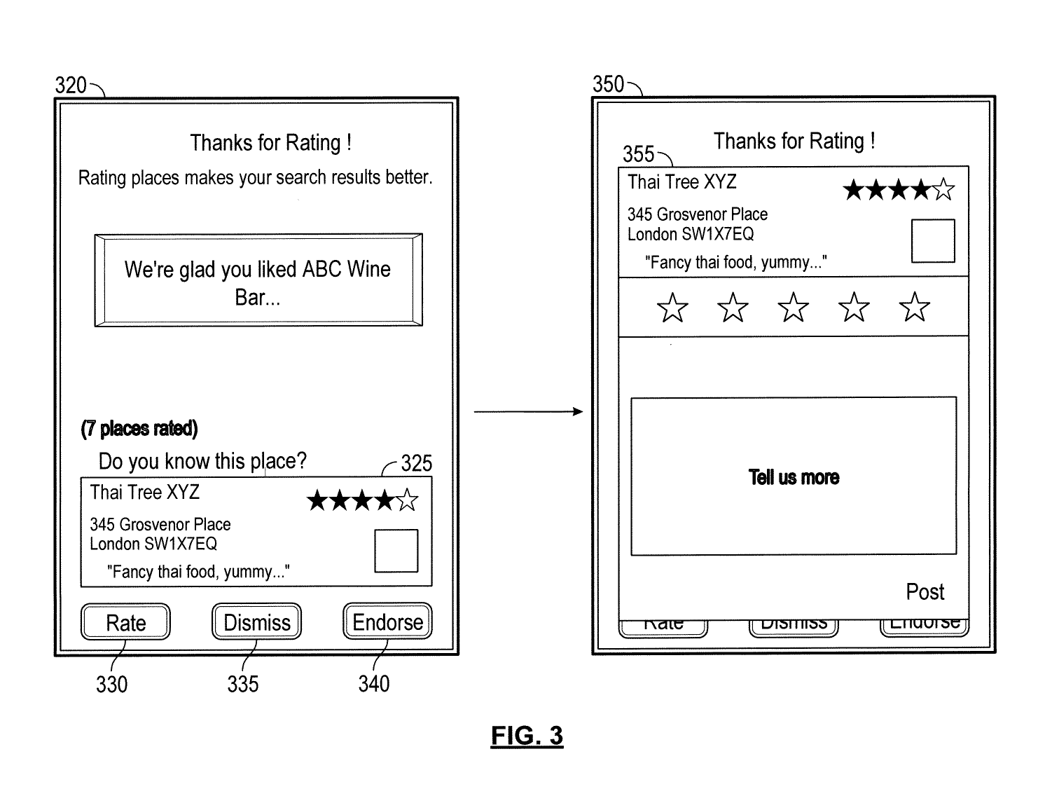

For example, FIG. 3 is an example user interface 300 displayed to a user after the system receives a rating submitted by a user, in accordance with various aspects of the subject technology. In a first instance 320 of user interface 300 may be presented to a user in response to receiving, from the user, the user's 7th rating.

The first instance 320 of the user interface 300 may include a recommendation 325 for “Thai Tree XYZ” as well as interface control elements to rate 330, dismiss 335, or endorse 340 the recommendation 325. If the user performs any of these actions via the interface control elements, the current recommendation (e.g., “Thai Tree XYZ”) may be replaced by a new recommendation. For example, the current recommendation 325 may be replaced by another recommendation.

In another aspect, when the user selects the recommendation 325, a new interface element may appear (e.g., a large, floating interface element may slide onto the first instance 320 of the user interface 300) that allows the user to rate the current recommendation. For example, in the second instance 350 of the user interface 300, a new interface element 355 has been displayed to the user in response to the user selecting the recommendation 325. The new interface element 355 may enable the user to rate the recommendation 325 and/or input additional comments about the recommendation 325.

### Generating Recommendations

According to one aspect of the subject technology, recommendations for a user may be generated for the user by the recommendation module 130 based on factors such as, for example, one or more characteristics of the user, recommendations received from other users that are similar to the user, topics similar to the topics rated by the user, or a combination of these. For example, the recommendation module 130 may identify a list of other users that are considered to be similar to the user (e.g., like-minded users). Similar users may be identified, for example, as users that have rated the same or similar topics in a similar way as the user, and/or users who share certain characteristics in common with the user.

Once a list of similar users are identified, the recommendation module 130 may rank the topics rated by the similar users and identify a number of the highest-ranked topics. The highest-ranked topics may be used to generate recommendations for the user. According to one aspect, the topics may be ranked based on the ratings given to the topics by the similar users (e.g., topics with higher average ratings are ranked higher than topics with lower average ratings).

In other aspects, the rankings of the topics may be affected based on the user's most recently rated topic. For example, if a topic is a point of interest, its ranking may be weighted based on its distance from a point of interest the user most recently rated (e.g., so that a point of interest nearest to the point of interest the user just rated may be ranked higher than a point of interest that is further away). In another example, the ranking of topics may be weighted based on similarities to the topic most recently rated by the user. For example, if the user recently rated a coffee shop, coffee shops rated by similar users may be weighted so that they rank higher than other topics rated by similar users, such as shoe stores or bowling alleys (e.g., topics in a different category than the most recently rated topic).

According to one aspect, topics that the user has already rated may be filtered out so that the user will not be presented with recommendations for topics that the user is already familiar with. The remaining highest-rated topics may be used to generate recommendations for the user.

### Multiple Thresholds

According to various aspects of the subject technology, more than one threshold may be used to generate and provide recommendations to a user. For example, the recommendation module 130 may generate a first set of recommendations for a user once the interface module 120 receives a first threshold number of ratings for the user. A subset of these ratings may be shown to the user (e.g., as a reward) for submitting the first threshold number of ratings. Additionally, along with the recommendations, the user may be presented a message informing the user of a second threshold. For example, the message may read “Rate 5 more places to get new recommendations.”

In some aspects, additional recommendations from the first set of recommendations may be provided to the user for each additional rating the user submits after the user surpasses the first threshold, but before the user reaches the second threshold. Once the user submits enough ratings to reach the second threshold number of ratings, the system may recalculate the recommendations for the user based on all of the ratings the user has submitted, user characteristics, other like-minded users, or a combination of these.

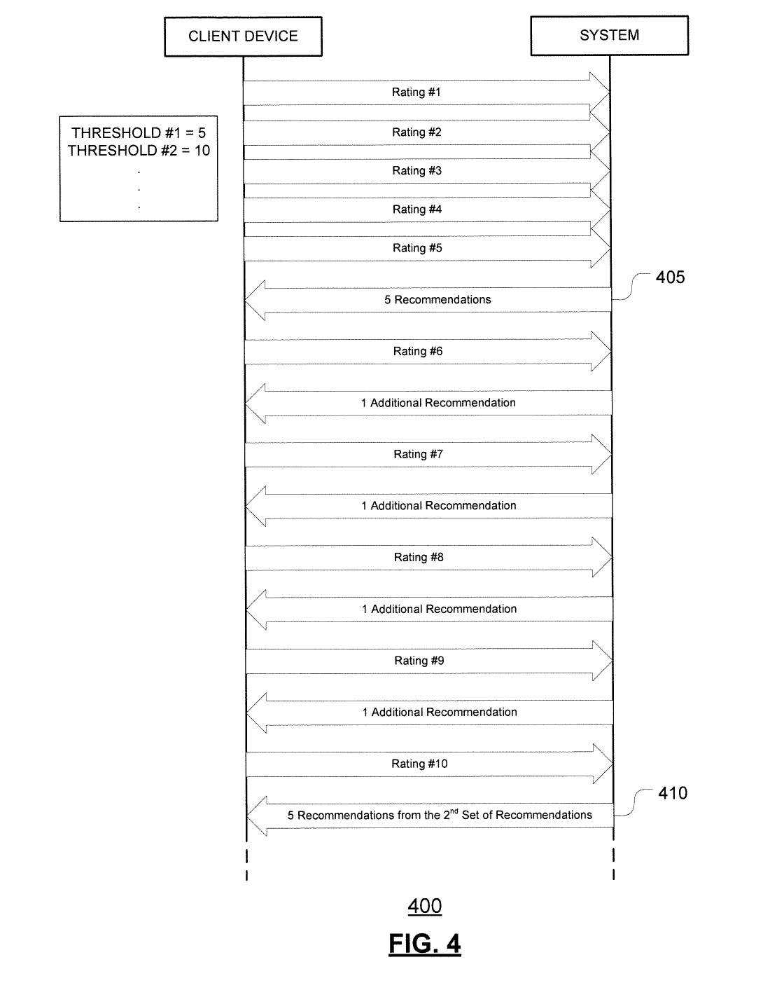

FIG. 4 is a timing diagram 400 that illustrates an example interaction between a user on a client device and a system configured to providing recommendations as an incentive, according to various aspects of the subject technology. In FIG. 4, a user on a client device may submit ratings up to the threshold number of ratings (e.g., 5). Once the user has submitted the threshold number of ratings, the system will generate a first set of recommendations for the user based on, for example, the ratings submitted to the user up to this point. At 405, the system may provide a subset of one or more of the first set of recommendations to the user. In the example shown in FIG. 4, 5 recommendations are provided to the user.

In response to each additional rating submitted by the user, but before the user reaches the second threshold (e.g., Rating #6, Rating #7, Rating #8, and Rating #9), the system may provide an additional recommendation from the first set of recommendations. Once the user has submitted enough ratings to reach the second threshold (e.g., 10 ratings), the system will generate a second set of recommendations for the user based on, for example, the ratings submitted to the user up to this point. At 410, the system may provide to the user a subset of the second set of recommendations. In some aspects additional thresholds may be reached in a similar way.

By providing multiple thresholds, the system is able to provide the additional incentive of recalculated recommendations for the user. Furthermore, as the user submits more and more ratings, the recalculated recommendations may be more accurate and more personalized to the user because the recommendations, which are calculated based on the users ratings, may be calculated using more data points.

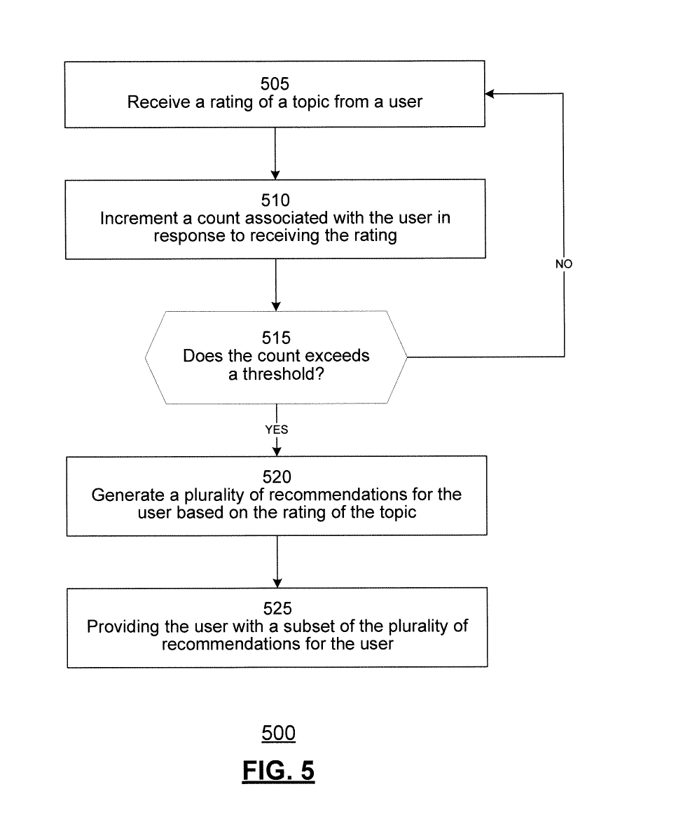

FIG. 5 is a flow chart illustrating an example process for providing recommendations as an incentive for a user to contribute a rating on a topic, in accordance with various aspects of the subject technology. Although the steps in process 500 are shown in a particular order, certain steps may be performed in different orders or at the same time. Furthermore, although the steps are discussed as being performed by the modules of the server 115 in FIG. 1, the steps are not limited to being performed by these modules.

At step 505, the interface module 120 may receive a user rating of a topic from a client machine. The user rating may be associated with a user and contain information such as, for example, a user identifier (e.g., a user name), a topic identifier that references the topic being rated by the user, a rating for the topic, comments about the topic, and/or any other information that may be used to rate a topic or provide topic recommendations.

In response to receiving the user rating, the threshold module 125 may increment a count associated with the user in response to receiving the rating at step 510 and determine whether the count associated with the user exceeds a threshold at step 515. If the count does not exceed the threshold, the incentive module 130 may provide a message informing the user that additional ratings are needed before recommendations can be provided.

If the count exceeds the threshold, the recommendation module 130 may generate a set of recommendations for the user based on, for example, the ratings the user has submitted at step 520. Once the set of recommendations has been generated, the incentive module 135 may determine which of the recommendations to provide to the user and, at step 525, provide the user a subset of the recommendations.

The incentive module 135 may determine which of the recommendations to provide to the user by ranking the set of recommendations. In one aspect, the ranking may be based on how high each recommended topic was rated by similar users. In some cases, the ranking may also be based on the user rated topic most recently received by the interface module 120. For example, if the user rated topic most recently received by the interface module 120 was for a coffee shop at a particular location, the incentive module 135 may rank the recommended topics that are closer to the location of the coffee shop higher. The incentive module 135 may also rank recommendations of other coffee shops or restaurants (e.g., of other topics in the same or similar categories) higher based on their similarity to the user's most recently rated topic.

Although some aspects refer to providing recommendations in exchange for receiving ratings of topics, various aspects of the subject technology may also provide recommendations in exchange for receiving user reviews, comments, or other topical content from users. For example, the count associated with a user may also be incremented based on receiving a review or comments about a topic from the user, thereby allowing the review or comments about the topic to be used to generate recommendations. For example, a review or comment may be analyzed using one or more techniques such as semantic analysis or identifying key terms in order to identifying the user and the topic that is the subject of the review or comment. Based on the analysis and the counts associated with the user, the recommendation module 130 may generate a set of recommendations for the user.

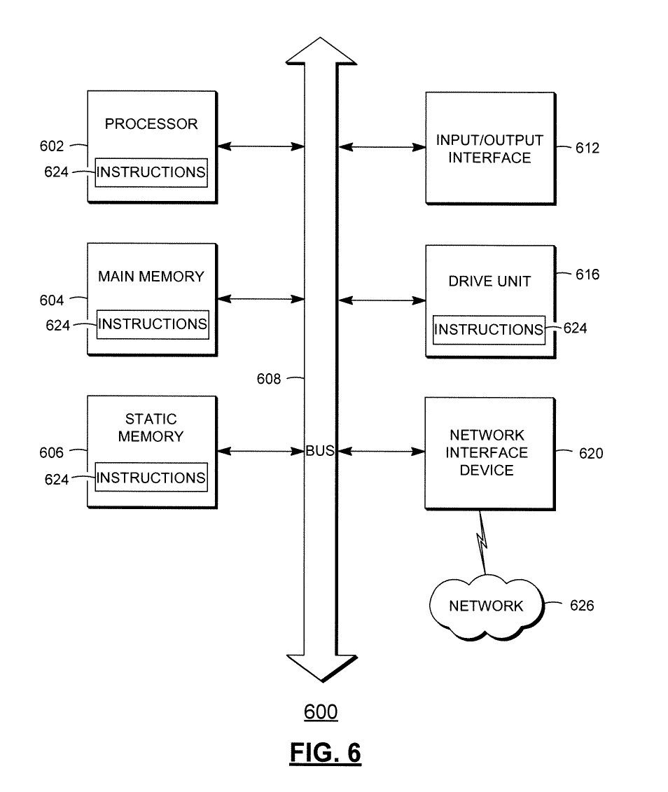

FIG. 6 is a block diagram illustrating an example computer system with which any of the clients, servers, or systems described herein may be implemented, in accordance with various aspects of the subject technology. In certain aspects, the computer system 600 may be implemented using hardware or a combination of software and hardware, either in a dedicated server, or integrated into another entity, or distributed across multiple entities.

The example computer system 600 includes a processor 602, a main memory 604, a static memory 606, a disk drive unit 616, and a network interface device 620 which communicate with each other via a bus 608. The computer system 600 may further include an input/output interface 612 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 602 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 624 embodying any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media. The instructions 624 may further be transmitted or received over a network 626 via the network interface device 620.

The machine-readable medium may be a single medium or multiple media (e.g., a centralized or distributed database, and/or associated caches and servers) that store the one or more sets of instructions. The machine-readable medium may comprise the drive unit 616, the static memory 606, the main memory 604, the processor 602, an external memory connected to the input/output interface 612, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as preferred or advantageous over other aspects or designs.

What is claimed is:

1. A method for providing recommendations in response to receiving a rating, the method comprising:
receiving a rating of a first topic by a user;
incrementing a count for the user in response to receiving the rating of the first topic;
determining that the count exceeds a first threshold; and
generating a first plurality of recommendations for the user, and
providing a subset of the first plurality of recommendations for the user.

2. The method of claim 1, wherein the first plurality of recommendations is generated based on user characteristics obtained from a profile for the user.

3. The method of claim 1, wherein the first plurality of recommendations is generated based on characteristics from a plurality of other topics rated by the user.

4. The method of claim 1, wherein the first plurality of recommendations is generated based on characteristics of the first topic.

5. The method of claim 1, further comprising:
receiving a rating of a second topic by the user; and
providing at least one additional recommendation from the first plurality of recommendations to the user.

6. The method of claim 1, further comprising:
receiving a rating of a second topic by the user;
incrementing the count for the user in response to receiving the rating of the second topic;
determining that the count exceeds a second threshold; and
generating a second plurality of recommendations for the user, and
providing a subset of the second plurality of recommendations for the user.

7. The method of claim 1, wherein the first plurality of recommendations is generated based on topics rated by other users that are similar to the user.

8. The method of claim 1, wherein the topic comprises at least one of a point of interest, a product, or a service.

9. The method of claim 1, wherein each recommendation in the subset of the first plurality of recommendations comprises a recommendation for a topic for which the user has not submitted a rating.

10. The method of claim 4, wherein the characteristics of the first topic include a location of the first topic and a category for the first topic.

11. A system for providing recommendations in response to receiving a rating, the system comprising:
one or more processors; and
a machine-readable medium comprising instructions stored therein, which when executed by the one or more processors, cause the one or more processors to perform operations comprising:
receiving a rating of a first topic by a user;
incrementing a count for the user in response to receiving the rating of the first topic;
determining that the count exceeds a first threshold;
generatinga first plurality of recommendations for the user; and
providing a subset of the first plurality of recommendations for the user.

12. The system of claim 11, wherein the first plurality of recommendations is generated based on at least one of characteristics of the first topic, user characteristics obtained from a profile for the user, characteristics from a plurality of other topics rated by the user, or topics rated by other users that are similar to the user.

13. The system of claim 11, wherein the operations performed by the one or more processors further comprise:
receiving a rating of a second topic by the user;
incrementing the count for the user in response to receiving the rating of the second topic;
determining that the count exceeds a second threshold;
generating a second plurality of recommendations for the user, and
providing a subset of the second plurality of recommendations for the user.

14. The system of claim 13, wherein if the count does not exceed the second threshold, the operations further comprise:
providing at least one additional recommendation of the first plurality of recommendations to the user in response to the receiving of the rating of the second topic.

15. The system of claim 1, wherein the topic comprises at least one of a point of interest, a product or a service.

16. A non-transitory machine-readable medium comprising instructions stored therein, which when executed by a machine, cause the machine to perform operations comprising:
receiving a user rating of a topic from a client device;
incrementing a count associated with the user in response to receiving the user rating of the topic;
determining that the count exceeds a threshold;
generating a plurality of recommendations for the user, and
providing a subset of the plurality of recommendations for the user.

17. The non-transitory machine-readable medium of claim 16, wherein the plurality of recommendations is generated based on at least one of characteristics of the topic, user characteristics obtained from a profile for the user, characteristics from a plurality of other topics rated by the user, or topics rated by other users that are similar to the user.

18. The non-transitory machine-readable medium of claim 16, wherein the operations further comprise:
receiving a rating of a second topic by the user; and
providing at least one additional recommendation of the first plurality of recommendations to the user in response to the receiving of the rating of the second topic.

19. The non-transitory machine-readable medium of claim 16, wherein the topic comprises at least one of a point of interest, a product, or a service.

20. The non-transitory machine-readable medium of claim 16, wherein each recommendation in the plurality of recommendations comprises information about a topic for which the user has not submitted a rating.
